(19) United States
(12) Patent Application Publication
(10) Pub. No.: US 2012/0056802 A1
(43) Pub. Date: Mar. 8, 2012

(54) Program, Object Control Method, And Game Device

(75) Inventors: Takamitsu Iijima, Tokyo (JP); Shinji Aizawa, Tokyo (JP)

(73) Assignee: SONY COMPUTER ENTERTAINMENT INC., Tokyo (JP)

(21) Appl. No.: 13/214,427

(22) Filed: Aug. 22, 2011

(30) Foreign Application Priority Data
Sep. 2, 2010 (JP) 2010196333

(51) Int. Cl. G09G 5/00

(52) U.S. Cl. 345/156

(57) ABSTRACT

A behavior table storage unit stores correspondence between a predetermined action of an object and a condition for operation of an input device. A condition determination unit determines whether control information of the input device meets the condition for operation stored in the behavior table storage unit. An object control unit causes, when the condition for operation is determined to be met, the object to perform an action mapped to the condition for operation. The behavior table storage unit stores a condition for operation requiring that the input device be moved by a predetermined amount within a predetermined period of time, and the condition determination unit measures time elapsed since the start of movement of the input device and determines, when the input device is moved by the predetermined amount within the predetermined period of time, that the condition for operation is met.

### BACKGROUND OF THE INVENTION

1. Field of the Invention

The present invention relates to game control technology and, particularly, to a game device that allows a user to control an object such as a game character by using an input device.

2. Description of the Related Art

In association with the improvement in the processing capabilities of game devices, a great number of games are now available that allow a user to control a game character in a game field created by three-dimensional modeling. There is also proposed a technology of capturing an image of a user-manipulated real object with a camera and using the motion of the real object captured with the camera image as an input to the game, as well as using an input provided by a button operation.
[patent document No. 1] U.S. Pat. No. 6,795,068

An input device and a game are closely related to each other. As a novel input device becomes available, game applications that utilize the uniqueness of the input device are developed. Propelled by the need to service diversified demand from users, we have come to hold an idea of a novel game application that is run in coordination with an input device manipulated by a user.

### SUMMARY OF THE INVENTION

A purpose of the present invention is to provide a technology of reflecting the motion of an input device manipulated by a user in the action of an object in a game.

In order to address the above-described issue, the computer program according to one embodiment of the present invention embedded in a non-transitory computer-readable recording medium, comprises: a module configured to determine whether control information indicating an operation of an input device meets a predetermined condition for operation; and a module configured to cause, when the condition for operation is determined to be met, an object to perform an action mapped to the condition for operation. The predetermined condition for operation requires that the input device be moved by a predetermined amount within a predetermined period of time. The determination module measures time elapsed since the start of a movement of the input device and determines, when the input device is moved by the predetermined amount within the predetermined period of time, that the condition for operation is met.

The computer program according to another embodiment of the present invention embedded in a non-transitory computer-readable recording medium, comprises: a module configured to determine whether control information indicating an operation of an input device meets a predetermined condition for operation; and a module configured to cause, when the condition for operation is determined to be met, an object to perform an action mapped to the condition for operation. The condition for operation to cause the object to jump in a game space requires that the input device is directed substantially in the vertical direction and that the input device be moved upward in the vertical direction. When the determination module determines that the condition for operation to cause the object to jump is met, the module for object control causes the object to jump in the game space.

Still another embodiment of the present invention relates to an object control method. The method is adapted to cause an object to perform an action in accordance with an operation using an input device, and comprises: acquiring an image of an input device having a light-emitting body; acquiring control information indicating an operation of the input device by referring to positional information of the input device derived from the acquired image, and/or orientation information of the input device; storing the correspondence between a predetermined action of the object and a condition for operation of the input device; determining whether the control information meets the condition for operation; and causing, when the condition for operation is determined to be met, the object to perform an action mapped to the condition for operation. Said storing stores a condition for operation requiring that the input device be moved by a predetermined amount within a predetermined period of time, and said determination measures time elapsed since the start of a movement of the input device and determines, when the input device is moved by the predetermined amount within the predetermined period of time, that the condition for operation is met.

Still another embodiment of the present invention relates to a game device adapted to cause an object to perform an action in accordance with an operation using an input device. The game device comprises; an image acquisition unit configured to acquire an image of an input device having a light-emitting body; a control information acquisition unit configured to acquire control information indicating an operation of an input device by referring to positional information of the input device derived from the acquired image, and/or orientation information of the input device; a storage unit configured to store correspondence between a predetermined action of the object and a condition for operation of the input device; a condition determination unit configured to determine whether the control information meets the condition for operation stored in the storage unit; and an object control unit configured to cause, when the condition for operation is determined by the condition determination unit to be met, the object to perform an action mapped to the condition for operation. The storage unit stores a condition for operation requiring that the input device be moved by a predetermined amount within a predetermined period of time, and the condition determination unit measures time elapsed since the start of a movement of the input device and determines, when the input device is moved by the predetermined amount within the predetermined period of time, that the condition for operation is met. The control information of the input device may be the positional information and/or orientation information of the input device itself or the information derived from the positional information and orientation information by computation.

Optional combinations of the aforementioned constituting elements, and implementations of the invention in the form of methods, apparatuses, systems, recording mediums and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an environment in which a game system according to an embodiment of the present invention is used;

FIGS. 2A and 2B show the appearance of the input device;

FIG. 3 shows the internal configuration of the input device;

FIG. 4 shows the internal configuration of the game device;

FIG. 5 shows a coordinate system for defining the positional information and orientation information of the input device in the device information processing unit;

FIG. 6 shows the configuration of the application processing unit;

FIG. 7 shows an example of game scene assumed in the embodiment;

FIG. 8 shows an example of a table mapping predetermined behaviors of a game object to conditions for operation of the input device that trigger the behaviors;

FIG. 9A shows a state in which the user swings the light-emitting body to the left; and FIG. 9B shows a state in which the user swings the light-emitting body to the right;

FIG. 10 shows the range of pitch angle β and yaw angle α of the input device defined by the first and second conditions;

FIG. 11A shows how the second condition is met; and FIG. 11B shows how the first condition is met;

FIG. 12 shows an example of flow of determination on condition performed when a plurality of conditions for operation are defined; and

FIG. 13 shows another example of flow of determination on condition performed when a plurality of conditions for operation are defined.

### DETAILED DESCRIPTION OF THE INVENTION

The invention will now be described by reference to the preferred embodiments. This does not intend to limit the scope of the present invention, but to exemplify the invention.

An embodiment of the present invention provides a game device configured to acquire positional information and/or orientation information in a real space of an input device functioning as a game controller as game control information and capable of running game software in accordance with the control information.

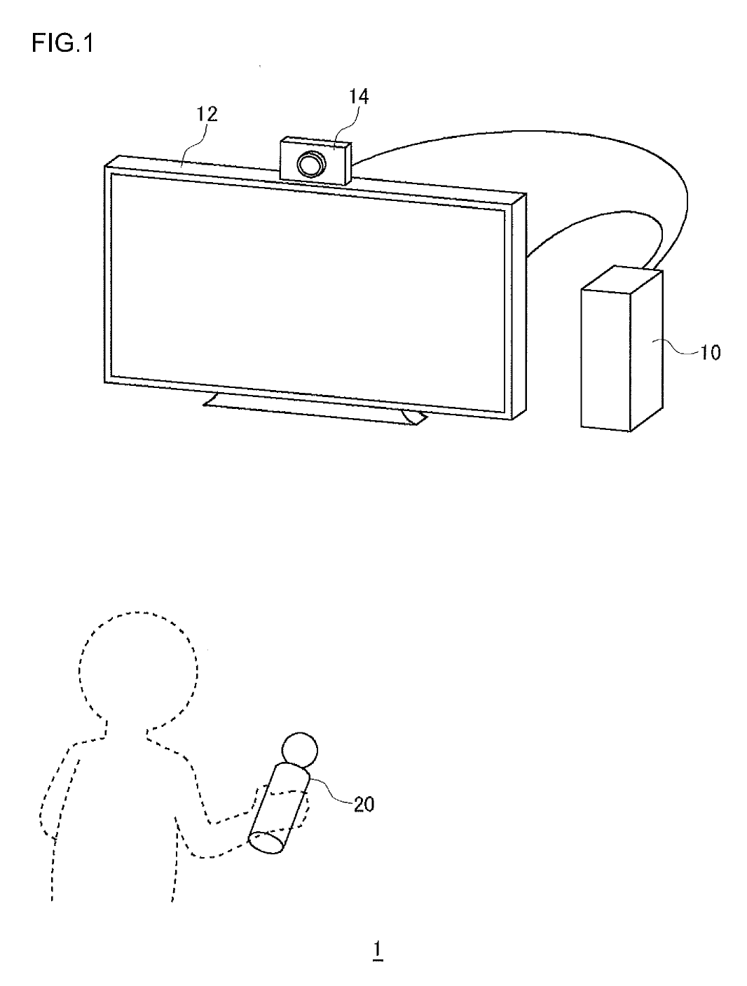

FIG. 1 shows an environment in which a game system 1 according to an embodiment of the present invention is used. The game system 1 comprises a game device 10 adapted to run game software, a display device 12 adapted to output a result of processing by the game device 10, an input device 20, and an imaging device 14 adapted to image the input device 20.

The input device 20 is a user input device that allows a user to provide a command. The game device 10 is a processing device adapted to run a game program in accordance with a user command provided via the input device 20 and generate an image signal indicating a result of game processing.

The input device 20 is driven by a battery and is provided with multiple buttons for providing a user command. As the user operates the button of the input device 20, information on the state of the button is transmitted to the game device 10. The game device 10 receives the button state information from the input device 20, controls the progress of the game in accordance with the user command associated with the button state information, and generates a game image signal. The generated game image signal is output from the display device 12.

The input device 20 has the function of transferring the button state information produced by the user to the game device 10 and is configured according to the embodiment as a wireless controller capable communicating with the game device 10 wirelessly. The input device 20 and the game device 10 may establish wireless connection using the Bluetooth (registered trademark) protocol. The input device 20 may not be a wireless controller but may be connected to the game device 10 using a cable.

The imaging device 14 is a video camera comprising a CCD imaging device, a CMOS imaging device, or the like. The device 14 captures an image of a real space at predetermined intervals so as to generate frame images. For example, the imaging device 14 may capture 60 images per second to match the frame rate of the display device 12. The imaging device 14 is connected to the game device 10 via a universal serial bus (USB) or another interface.

The display device 12 is a display that outputs an image and displays a game screen by receiving an image signal generated by the game device 10. The display device 12 may be a television set provided with a display and a speaker. Alternatively, the display device 12 may be a computer display. The display device 12 may be connected to the game device 10 using a cable. Alternatively, the device 12 may be wirelessly connected using a wireless local area network (LAN).

The input device 20 in the game system 1 according to the embodiment is provided with a light-emitting body. The light-emitting body of the input device 20 is configured to emit light of multiple colors. The color emitted by the light-emitting body can be configured according to a command for light emission from the game device 10. During the game, the light-emitting body emits light of a predetermined color, which is imaged by the imaging device 14. The imaging device 14 captures an image of the input device 20 and generates a frame image, supplying the image to the game device 10. The game device 10 acquires the frame image and derives information on the position of the light-emitting body in the real space in accordance with the position and size of the image of the light-emitting body in the frame image. The game device 10 deals the positional information as a command to control the game and reflects the information in game processing by, for example, controlling the action of a player's character. The game device 10 according to the embodiment is provided with the function of running a game program not only using the button state information of the input device 20 but also using the positional information of the acquired image of the light-emitting body.

The input device 20 is provided with an acceleration sensor and a gyro sensor. The value detected by the sensor is transmitted to the game device 10 at predetermined intervals. The game device 10 acquires the value detected by the sensor and acquires information on the orientation of the input device 20 in the real space. The game device 10 deals the orientation information as a user command in the game and reflects the information in game processing. Thus, the game device 10 according to the embodiment has the function of running a game program using the acquired orientation information of the input device 20. The game device 10 not only deals with the positional information and orientation information of the input device 20 directly as a user command but also deals with information derived from the information by computation as a user command.

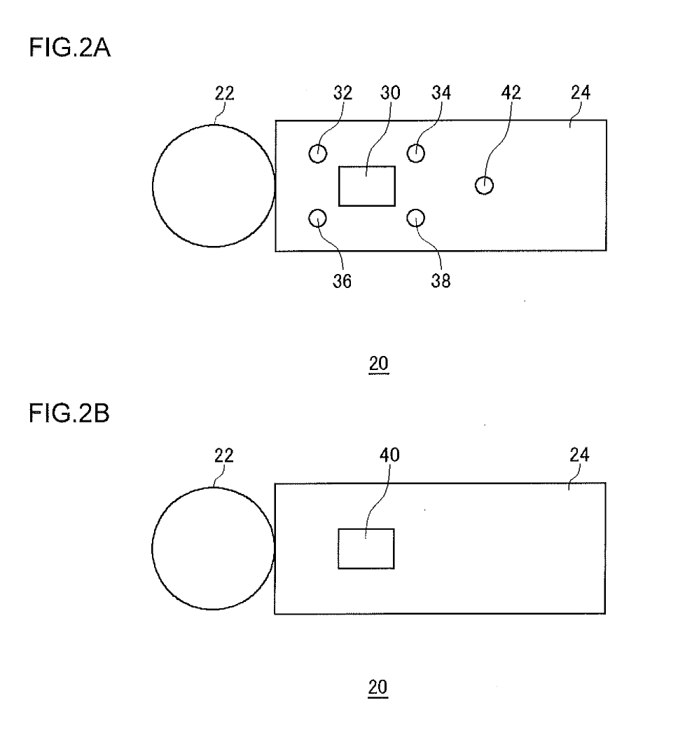

FIGS. 2A and 2B show the appearance of the input device 20. FIG. 2A shows the top surface of the input device 20, and FIG. 2B shows the bottom surface of the input device 20. The input device 20 comprises a light-emitting body 22 and a substantially cylindrical handle 24. The exterior of the light-emitting body 22 is formed of a light-transmitting resin to have a spherical form. The light-emitting body 22 is provided with a light-emitting device such as a light-emitting diode or an electric bulb inside. When the light-emitting device inside emits light, the entirety of the exterior sphere is lighted. Control buttons 30, 32, 34, 36, and 38, and a start button 42 are provided on the top surface of the handle 24, and a control button 40 is provided on the bottom surface. The control buttons 30, 32, 34, 36, and 38 are controlled by the thumb of the user holding the ends of the handle 24 with the hands. The control button 40 is controlled by the index finger. The control buttons 30, 32, 34, 36, and 38, and the start button 42 are configured such that the buttons can be pressed. The control button 40 may be rotatable.

The user plays the game viewing the game screen displayed on the display device 12. Because it is necessary to capture an image of the light-emitting body 22 while the game software is being run, the imaging device 14 is preferably oriented to face the same direction as the display device 12. Typically, the user plays the game in front of the display device 12. Therefore, the imaging device 14 is arranged such that the direction of the light axis thereof is aligned with the frontward direction of the display device 12. More specifically, the imaging device 14 is preferably located to include in its imaging range those positions in the neighborhood of the display device 12 where the user can view the display screen of the display device 12. This allows the imaging device 14 to capture an image of the input device 12 held by the user playing the game.

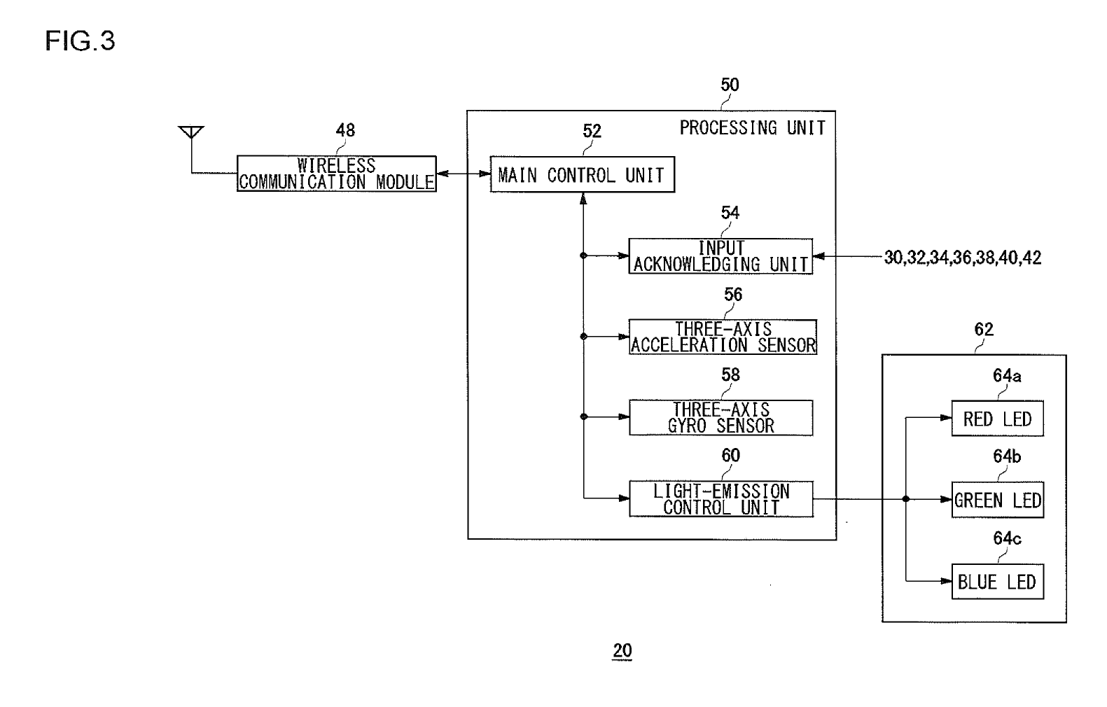

FIG. 3 shows the internal configuration of the input device 20. The input device 20 comprises a wireless communication module 48, a processing unit 50, a light-emitting unit 62, the control buttons 30, 32, 34, 36, 38, and 40, and the start button 42. The wireless communication module 48 has the function of transmitting and receiving data to and from the wireless communication module of the game device 10. The processing unit 50 performs various processes in the input device 20.

The processing unit 50 comprises a main control unit 52, an input acknowledging unit 54, a three-axis acceleration sensor 56, a three-axis gyro sensor 58, and a light-emission control unit 60. The main control unit 52 exchanges necessary data with the wireless communication module 48.

The input acknowledging unit 54 acknowledges input information from the control buttons 30, 32, 34, 36, 38, and 40 and sends the information to main control unit 52. The three-axis acceleration sensor 56 detects acceleration components in three directions defined by X, Y, and Z axes. The three-axis gyro sensor 58 detects angular velocity on the xz plane, zy plane, and yx plane. In this embodiment, the width direction of the input device 20 is defined as the x-axis, the height direction as the y-axis, and the longitudinal direction as the z-axis. The three-axis acceleration sensor 56 and the three-axis gyro sensor 58 are provided in the handle 24 of the input device 20 and, more preferably, in the center or the neighborhood of the center of the handle 24. Along with the input information from the control buttons, the wireless communication module 48 sends information on the value detected by the three-axis acceleration sensor 56 and information on the value detected by the three-axis gyro sensor 58 to the wireless communication module of the game device 10 at predetermined intervals. The interval of transmission is set to, for example, 11.25 milliseconds.

The light-emission control unit 60 controls light emission from the light-emitting unit 62. The light-emitting unit 62 comprises a red LED 64a, a green LED 64b and a blue LED 64c and is capable of emitting light of multiple colors. The light-emission control unit 60 adjusts light-emission from the red LED 64a, green LED 64b and blue LED 64c so as to cause the light-emitting unit 62 to emit light of a desired color.

In response to a command to emit light from the game device 10, the wireless communication module 48 supplies the command to the main control unit 52, whereupon the main control unit 52 supplies the command to the light-emission control unit 60. The light-emission control unit 60 controls light-emission from the red LED 64a, green LED 64b, blue LED 64c so as to cause the light-emitting unit 62 to emit light of a designated color. For example, the light-emission control unit 60 may controls light emission from the LEDs using pulse width modulation (PWM) control.

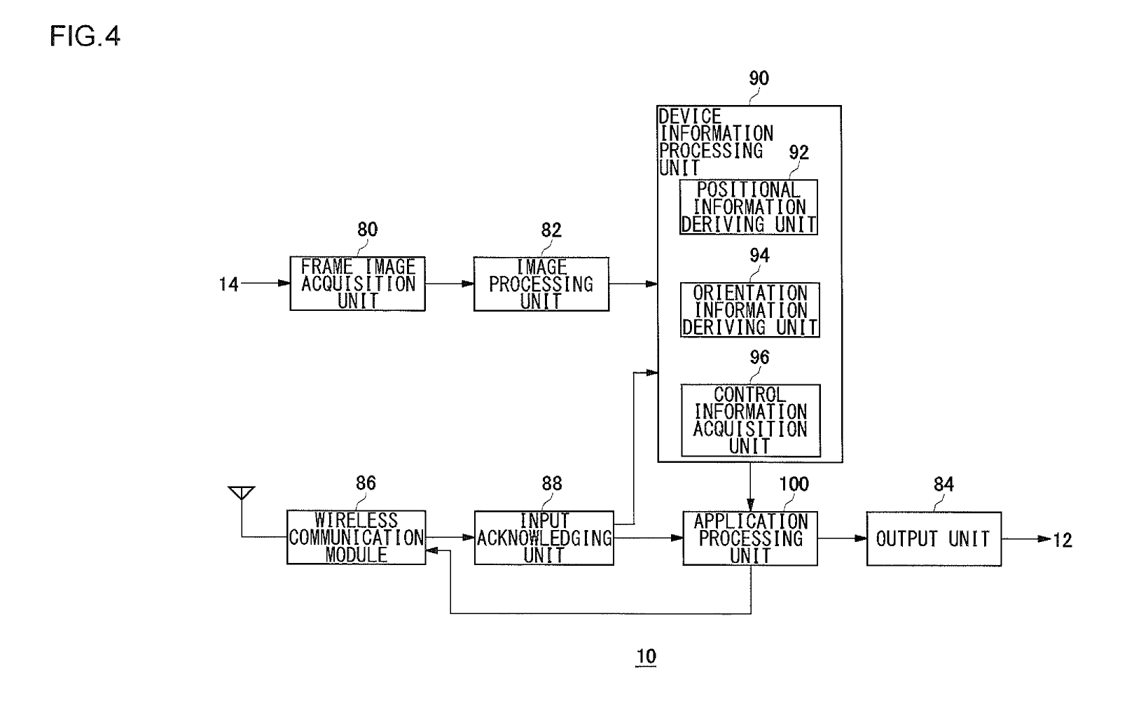

FIG. 4 shows the internal configuration of the game device 10. The game device 10 comprises a frame image acquisition unit 80, an image processing unit 82, a device information processing unit 90, a wireless communication module 86, an input acknowledging unit 88, an output unit 84, and an application processing unit 100. The device information processing unit 90 comprises a positional information deriving unit 92, an orientation information deriving unit 94, and a control information acquisition unit 96.

The functions of the game device 10 are implemented by a CPU, a memory, and a program or the like loaded into the memory. FIG. 4 depicts functional blocks implemented by the cooperation of these elements. The program may be built into the game device 10 or supplied from an external source in the form of a recording medium. Therefore, it will be obvious to those skilled in the art that the functional blocks may be implemented in a variety of manners by hardware only, software only, or a combination of thereof. The game device 10 may comprise a plurality of CPUs.

When the start button 42 of the input device 20 of the game system 1 according to the embodiment is pressed, a start request is transmitted to the game device 10, turning the power of the game device 10 on. The wireless communication module 48 calls the game device 10 using the identification information identifying the game device 10. The wireless communication module 86 of the game device 10 responds to the call so that connection is established between the wireless communication module 48 and the wireless communication module 86. The input device 20 operates as a master and the game device 10 operates as a slave. After the connection is established, the devices change roles. As a result of the communication process as described above, the input device 20 can transmit information on the status of the control buttons, and information on values detected by the three-axis acceleration sensor 56 and the three-axis gyro sensor 58 to the game device 10 at predetermined intervals.

The wireless communication module 86 receives information on the status of the control buttons and information on values detected by the sensors, which are transmitted by the input device 20, and supplies the information to the input acknowledging unit 88. The input acknowledging unit 88 isolates the button status information from the sensor detection information, delivering the button status information to the application processing unit 100, and the sensor detection information to the device information processing unit 90. The application processing unit 100 receives the button status information as a command to control the game.

The frame image acquisition unit 80 is configured as a USB interface and acquires fame images at a predetermined imaging speed (e.g., 60 frames/sec) from the imaging device 14. The image processing unit 82 extracts an image of the light-emitting body from the frame image. The image processing unit 82 identifies the position and size of the image of the light-emitting body in the frame image.

The image processing unit 82 may binarize the frame image data using threshold RGB values that depend on the emitted color of the light-emitting unit 62 and generate a binarized image. The light-emitting unit 62 emits light of a color designated by the game device 10 so that the image processing unit 82 can identify color of light emitted by the light-emitting unit 62. Therefore, the image of the light-emitting unit 62 can be extracted from the frame image by binarization. Binarization encodes pixel values of pixels having luminance higher than a predetermined threshold value into “1” and encodes pixel values of pixels having luminance equal to or lower than the predetermined threshold value into “0”. This allows the image processing unit 82 to identify the position and size of the image of the light-emitting body from the binarized image. For example, the image processing unit 82 identifies the barycentric coordinates of the image of the light-emitting body in the frame image and identifies the radius and area of the image of the light-emitting body.

When multiple users use input devices 20 so that multiple light-emitting bodies 22 are found in the frame image, the image processing unit 82 generates multiple binarized images using threshold values that depend on the emitted color of the respective light-emitting bodies 22, so as to identify the position and size of the images of the respective light-emitting bodies. The image processing unit 82 delivers the position and size of the image of the respective light-emitting body thus identified to the device information processing unit 90.

When the position and size of the image of the light-emitting body identified by the image processing unit 82 are acquired, the device information processing unit 90 derives the positional information of the input device 20 as viewed from the imaging device 14. Further, the device information processing unit 90 acquires the sensor detection information from the input acknowledging unit 88 and derives the information on the orientation of the input device 20 in the real space.

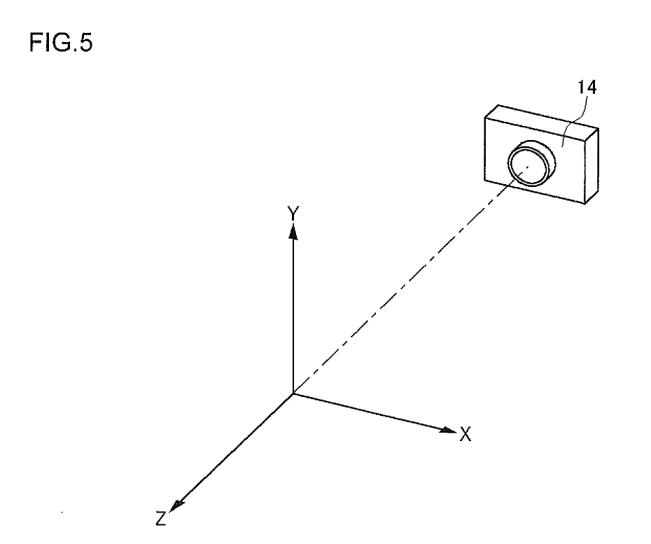

FIG. 5 shows a coordinate system for defining the positional information and orientation information of the input device 20 in the device information processing unit 90. The Z-axis is defined along the light axis of the imaging device 14, the X-axis is defined in the horizontal direction of the frame image captured by the imaging device 14, and the Y-axis is defined in the vertical direction. Therefore, the Z-axis is defined in the depth direction of the frame image. In the real space, it is favorable that the Y-axis be correctly defined in the vertical direction, and the X-axis and Z-axis be correctly defined in the horizontal plane. Before the game is started, the game device 10 allows the user to register the reference orientation of the input device 20. In the registration, the user holds the handle 24 to be aligned with the Z-axis so that the light-emitting body 22 faces the imaging device 14. The orientation information deriving unit 94 acquires the sensor detection information occurring when the input device 20 is held still and registers the sensor detection information occurring in the reference orientation (hereinafter, referred to as reference orientation information). Preferably, the reference orientation is registered while the user holds the input device 20, orienting the upper surface shown in FIG. 2A of the input device 20 to face upward in the vertical direction and orienting the lower surface shown in FIG. 2B of the input device to face downward in the vertical direction.

Once the reference orientation is registered, the orientation information deriving unit 94 derives the current orientation information by comparing the acquired sensor detection information with the reference orientation information. Referring to FIG. 5, the orientation information deriving unit 94 derives the pitch angle of the input device 20 as an angle with respect to the XZ-plane and derives the yaw angle as an angle with respect to the ZY-plane. Referring to FIG. 5, the pitch angle will be 90° if the light-emitting body 22 faces upward when the handle 24 is held to be parallel to the Y-axis direction (vertical direction). If the light-emitting body 22 faces downward, the pitch angle will be −90°. The yaw angle will be 90° if the light-emitting body 22 faces rightward with reference to the user facing the imaging device 14 when the handle 24 is held to be parallel to the X-axis direction (horizontal direction). If the light-emitting body 22 faces leftward, the yaw angle will be −90°. When the user holds the handle 24 such that the light-emitting body 22 is aligned with the handle 24 in the Z-axis direction (anteroposterior direction), facing the imaging device 14, the pitch angle and the yaw angle will both be 0°. The orientation information deriving unit 94 derives the roll angle of the input device 20 as an angle of twist from the reference orientation.

The positional information deriving unit 92 acquires the position and size of the image of the light-emitting body. The positional information deriving unit 92 derives the positional coordinates in the frame image by referring to the barycentric coordinates of the image of the light-emitting body. The unit 92 further derives information on the distance from the imaging device 14 by referring to the radius and area of the image of the light-emitting body. The positional information deriving unit 92 may be provided with a table mapping the barycentric position coordinate in the frame image, the radius (or area) of the image of the light-emitting body, and the distance, and may derive the distance information by referring to the table. The positional information deriving unit 92 uses the barycentric position coordinate in the frame image and the radius (or area) of the image of the light-emitting body to derive the distance information by computation. The positional information deriving unit 92 uses the positional coordinate in the frame image and the derived distance information to derive the information on the position of the light-emitting body 22 in the real space.

When the orientation information deriving unit 94 derives the orientation information of the input device 20 and when the positional information deriving unit 92 derives the positional information of the light-emitting body 22, the control information acquisition unit 96 receives the derived information and acquires the control information of the input device 20 accordingly. For example, the control information of the input device 20 acquired by the control information acquisition unit 96 includes the following items.
Angle of inclination of the input device 20
Speed at which the inclination of the input device 20 changes
Twist of the input device 20 (roll angle)
Vertical orientation of the input device 20 (pitch angle)
Horizontal orientation of the input device 20 (yaw angle)
Position of the light-emitting body 22
Moving speed of the light-emitting body 22
Acceleration of the light-emitting body 22
Position of the handle 24
Moving speed of the handle 24
Acceleration of the handle 24

The control information acquisition unit 96 acquires the angle of inclination of the input device 20, the speed at which the inclination changes, the roll angle, pitch angle, and the yaw angle from the sensor detection information or the orientation information derived in the orientation information deriving unit 94. Similarly, the control information acquisition unit 96 determines the moving speed and acceleration of the handle 24 from the sensor detection information or the orientation information. The control information acquisition unit 96 determines the position, moving speed, and acceleration of the light-emitting body 22 from the positional information of the light-emitting body derived in the positional information deriving unit 92. Further, the control information acquisition unit 96 has information of the relative position of the light-emitting body 22 and the handle 24 forming the input device 20. For example, by acquiring the orientation information of the input device 20 and the positional information of the light-emitting body 22, the control information acquisition unit 96 can acquire the positional information (e.g., the positional information of the barycenter) on the handle 24 by referring to the relative position of the light-emitting body 22 and the handle 24. The position, moving speed, and acceleration of the light-emitting body 22 may be determined from the sensor detection information or the orientation information derived in the orientation information deriving unit 94.

In the embodiment, the positional information of the light-emitting body 22 and the positional information of the handle 24 are dealt with as the positional information of the input device 20. Similarly, the moving speed information of the light-emitting body 22 and the moving speed information of the handle 24 are dealt with as the moving speed information of the input device 20. The acceleration information of the light-emitting body 22 and the acceleration information of the handle 24 are dealt with as the acceleration information of the input device 20.

As described above, the control information acquisition unit 96 acquires the control information of the input device 20 by referring to the positional information of the input device 20, the sensor detection information, and/or the orientation information of the input device 20. The control information acquisition unit 96 delivers the acquired control information to the application processing unit 100. The application processing unit 100 receives the control information of the input device 20 as a user command in the game.

The application processing unit 100 uses the control information and button status information of the input device 20 to advance the game, and generates an image signal indicating the result of processing the game application. The image signal is sent from the output unit 84 to the display device 12 and output as a displayed image.

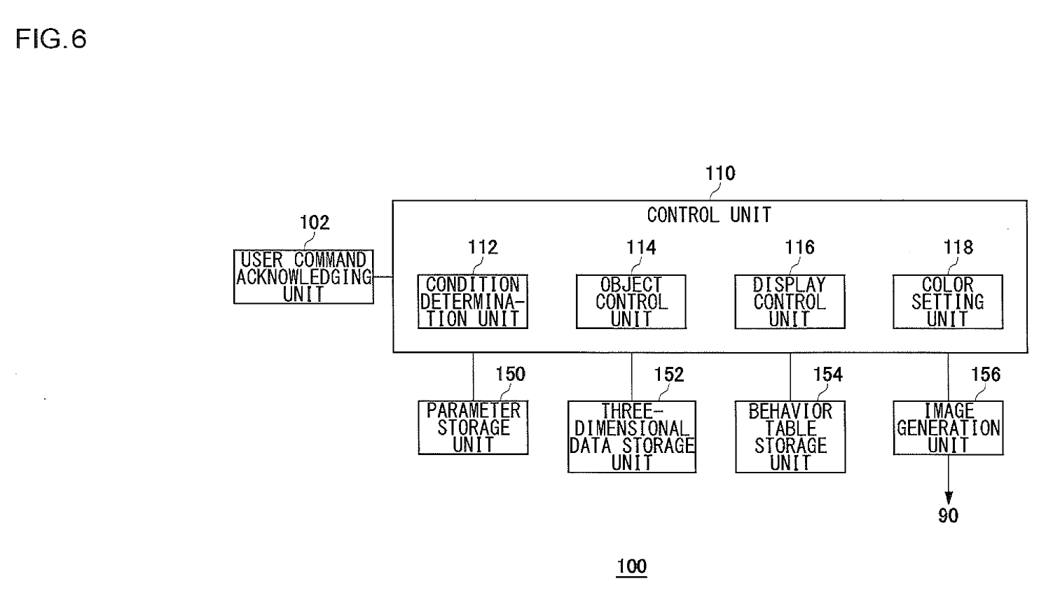

FIG. 6 shows the configuration of the application processing unit 100. The application processing unit 100 comprises a user command acknowledging unit 102, a control unit 110, a parameter storage unit 150, a three-dimensional data storage unit 152, a behavior table storage unit 154, and an image generation unit 156. The control unit 110 comprises a condition determination unit 112, an object control unit 114, a display control unit 116, and a color setting unit 118. The components of the application processing unit 100 represent various functions implemented by the game program. The parameter storage unit 150, the three-dimensional data storage unit 152 and the behavior table storage unit 154 may be one or more RAMs adapted to store data which are read from the game software.

The user command acknowledging unit 102 acknowledges control information of the input device 20 from the device information processing unit 90 and the button state information from the input acknowledging unit 88 as user commands. The control unit 110 runs the game and advances the game in accordance with the user commands acknowledged by the user command acknowledging unit 102. The parameter storage unit 150 stores parameters necessary for the progress of the game. The three-dimensional data storage unit 152 stores three-dimensional data forming the game space. The display control unit 116 controls the camera to render a three-dimensional game space in accordance with the movement of a game object and causes the image generation unit 156 to generate a display screen. The image generation unit 156 sets the viewpoint position and viewing direction of the camera in the game space and renders the three-dimensional data so as to generate a display screen representing the game space controlled by the control unit 110, i.e., a display screen that reflects the action of the game object.

The behavior table storage unit 154 maintains correspondence between certain types of behavior (action) of the game object and conditions for operation of the input device 20 (operations required to trigger the behaviors). A condition for operation is a condition to make the object to perform a corresponding behavior (action). The condition for operation may comprise a plurality of individual conditions. The behavior table storage unit 154 according to the embodiment maintains behaviors of a game object and conditions for operation in a table format. The unit 154 may maintain the correspondence in another format. The behavior table storage unit 154 may employ any format so long as behaviors of a game object and conditions for operation are mapped to each other. The condition determination unit 112 determines whether the control information acknowledged by the user command acknowledging unit 102 meets a condition stored in the behavior table storage unit 154.

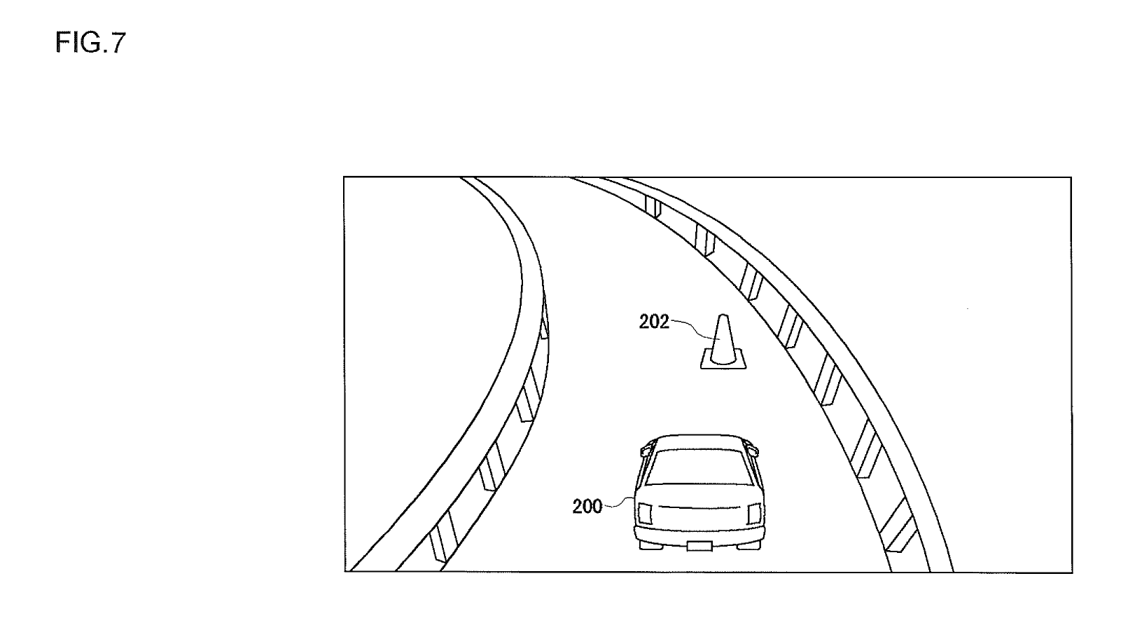

FIG. 7 shows an example of game scene assumed in the embodiment. In this game a game object 200 is a vehicle. Users compete against each other for faster time to reach a goal located down the road, navigating the vehicle around, for example, an obstacle 202. In this game, it is assumed that the vehicle travels down a slope automatically so that the user need not use the accelerator.

The obstacle 202 is a stationary object. The position of the obstacle 202 in the three-dimensional space is defined by the data stored in the three-dimensional data storage unit 152. The display control unit 116 determines the viewing direction and viewpoint position of the virtual camera in the game space defined in a world coordinate system, in accordance with the direction of movement of the game object 200 and the action performed that are determined by a user input command. The image generation unit 156 locates the virtual camera at the viewing position thus determined, renders the three-dimensional data stored in the three-dimensional data storage unit 152, aligning the light axis of the virtual camera in the viewing direction thus determined, and generates a display screen determined by the action of the game object.

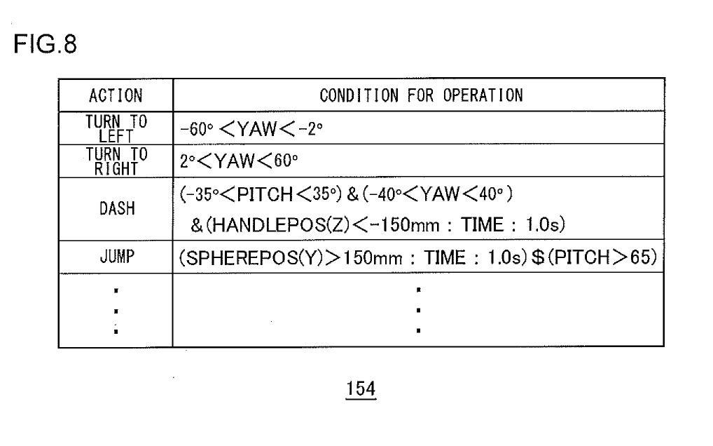

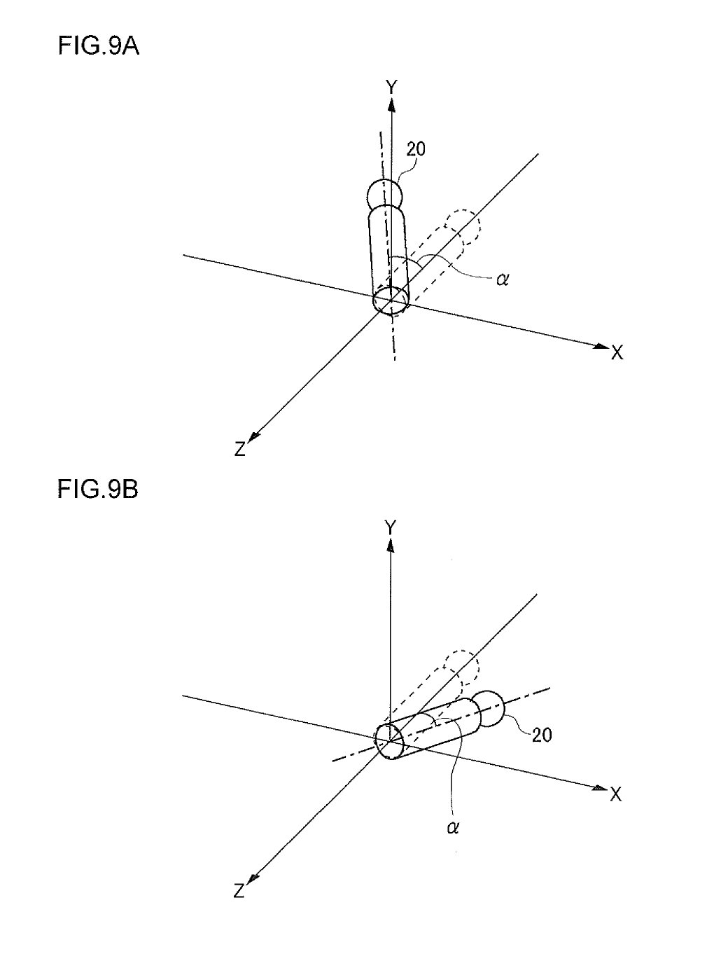

FIG. 8 shows an example of a table mapping predetermined behaviors (actions) of a game object to conditions for operation of the input device 20 that trigger the behaviors. Referring to the table “YAW” denotes a yaw angle, “PITCH” denotes a pitch angle, “HANDLEPOS(Z)” denotes the amount of movement of the handle 24 in the Z-axis direction, “SPHEREPOS(Y)” denotes the amount of movement of the light-emitting body 22 in the Y-axis direction, and “TIME” denotes a time limit. A description of the conditions for operation will now be given.

<Turn Action 1>“Turn to left” is an action of turning the steering wheel to the left. When the yaw angle is in a range “−60°<YAW(yaw angle)<−2°, the condition determination unit 112 determines that the condition to trigger “turn to left” is met. FIG. 9A shows a state in which the user swings the light-emitting body 22 to the left. Upon a determination that the yaw angle α is in the range (−60°<α<−2°), the condition determination unit 112 determines that the condition for operation mapped to the “turn to left” action is met. Upon a determination that the condition for operation is met, the condition determination unit 112 communicates the yaw angle α to the object control unit 114, whereupon the object control unit 114 causes the game object 200 to perform a predetermined action mapped to the condition for operation, i.e., “turn to left” in this case. In this process, the object control unit 114 sets an angle of turning the tire in accordance with the magnitude of the yaw angle α.

The image generation unit 156 generates a display screen showing the vehicle turning to the left.

<Turn Action 2>

“Turn to right” is an action of turning the steering wheel to the right. When the yaw angle is in a range “2°<YAW(yaw angle)<60°, the condition determination unit 112 determines that the condition to trigger “turn to right” is met. FIG. 9B shows a state in which the user swings the light-emitting body 22 to the right. Upon a determination that the yaw angle α is in the range (2°<α<60°), the condition determination unit 112 determines that the condition for operation mapped to the “turn to right” action is met. Upon a determination that the condition for operation is met, the condition determination unit 112 communicates the yaw angle α to the object control unit 114, whereupon the object control unit 114 causes the game object 200 to perform a predetermined action mapped to the condition for operation, i.e., “turn to right” in this case. In this process, the object control unit 114 sets an angle of turning the tire in accordance with the magnitude of the yaw angle α. The image generation unit 156 generates a display screen showing the vehicle turning to the right.

<Dash Action>

“Dash” is an action in which the vehicle speed is increased dramatically for a moment. The condition that triggers “dash” comprises a plurality of individual conditions that are bound by an operator “&”. The operator “&” signifies that the conditions should be met concurrently. By setting a condition for operation including a plurality of individual conditions for a single action, game applications that require user experience can be produced.

The first condition (−35°<PITCH<35°) requires that the pitch angle β of the input device 20 is within the range (−35°<PITCH (pitch)angle)<35°). The second condition (−40°<YAW(yaw)angle)<40°) requires that the yaw angle α of the input device 20 is within the range (−40°<YAW(yaw)angle)<40°). The third condition (HANDLEPOS(Z)<−150 mm:TIME;1.0 s) is decomposed into (HANDLEPOS(Z)<−150 mm) and (TIME:1.0 s). HANDLEPOS(Z)<−150 mm requires that the amount of movement of the handle 24 in the negative direction aligned with the Z-axis is more than 150 mm, and (TIME:1.0 s) requires that the movement is performed within one second. In other words, the third condition requires that the handle 24 be moved for a distance longer than 150 mm in the negative direction aligned with the Z-axis within one second. In the game system 1 according to the embodiment, the user generates a user command using the input device 20. Therefore, the time limit imposed on the manipulation of the input device 20 prompts the user to perform an speedy action and enjoy lively game operation.

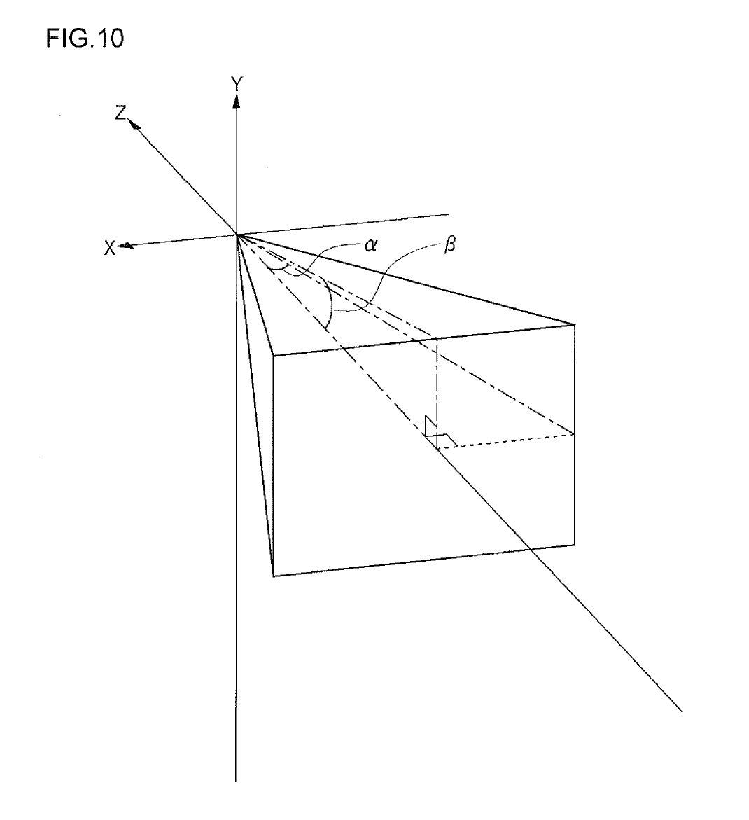

FIG. 10 shows the range of pitch angle β and yaw angle α of the input device 20 defined by the first and second conditions. The range is represented by a virtual square pyramid. If the user holds the input device 20 such that the axial line of the input device 20 is within the range defined by the square pyramid, if the user sticks the input device 20 in the negative direction aligned with the Z-axis within one second for a distance longer than 150 mm, the condition determination unit 112 determines that all of the first, second, and third conditions are met. To summarize the first through third conditions, the condition that triggers “dash” is that the user directs the light-emitting body 22 toward the imaging device 14, holds the input device 20 in a direction proximate to the Z-axis, and sticks the input device 20 quickly toward the imaging device 14 for a distance longer than 150 mm.

The condition determination unit 112 determines whether the individual conditions are met on an individual basis. For a “dash” action to take place, the third condition requires that the input device 20 is moved by a predetermined amount within a predetermined time. More specifically, the third condition requires that the movement of the handle 24 in the negative direction aligned with the Z-axis exceed 150 mm within one second. When the direction of movement of the handle 24 changes from the positive direction to the negative direction aligned with the Z-axis, or when the handle 24 begins to be moved in the negative direction, leaving the stationary state aligned with the Z-axis, the condition determination unit 112 detects the start of movement in the negative direction aligned with the Z-axis and starts measuring the time elapsed from the point of start of the movement. The movement of the handle 24 in the Z-axis direction is detected by referring to the positional information of the handle 24. More specifically, the condition determination unit 112 monitors the positional information of the handle 24 acquired as the control information. The condition determination unit 112 identifies the start of movement when the Z-coordinate value, which is found among the sequentially acquired positional information, changes to negative direction. When the amount of movement of the handle 24 goes beyond 150 mm within one second, the condition determination unit 112 determines that the third condition is met.

In this embodiment, the third condition may include the requirement requiring that the handle 24 moves continuously in the negative direction aligned with the Z-axis within one second. The requirement for continuous movement signifies that the Z-coordinate values found in the sequentially acquired positional information should remain unchanged or change in the negative direction (i.e., do not change in the positive direction). Therefore, when the handle 24 is moved in the positive direction aligned with the Z-axis before the amount of movement exceeds 150 mm, the amount of movement is canceled and set to 0. Thus, when the input device 20 is moved in the positive direction before the amount of movement exceeds 150mm since the start of movement in the negative direction aligned with the Z-axis, the condition determination unit 112 determines that the condition is not met upon detecting the movement in the positive direction.

Thus, when the condition determination unit 112 detects that the input device 20 is continuously moved for a distance longer than 150 mm within a predetermined period of time (in this case, one second) while the user keeps sticking the handle 24 in front without retracting the handle 24 toward the user, the condition determination unit 112 determines that the third condition is met. Meanwhile, when the input device 20 is moved in the positive direction aligned with the Z-axis before continuously moving 150 mm in the negative direction aligned with the Z-axis since the start of movement, the condition determination unit 112 determines at that point of time that the third condition is not met. When the input device 20 begins to be moved in the negative direction again, the condition determination unit 112 starts measuring time so as to monitor whether the third condition is met.

The condition determination unit 112 determines whether the individual conditions for triggering “dash” are met on an individual basis. The individual conditions are bound by an operator “&”, signifying that the conditions should be met concurrently to initiate the “dash” action. For each of the first through third conditions, the condition determination unit 112 sets a flag to 1 when the condition is met, and sets the flag to 0 when the condition is not met. When the flags of all individual conditions are set to 1, the condition determination unit 112 determines that all individual conditions are met and informs the object control unit 114 of the fact that the condition for triggering “dash” is met. The object control unit 114 causes the game object 200 to perform “dash”. The image generation unit 156 generates a display screen showing the vehicle speed to increase instantaneously.

<Jump Action>

A jump action is an action of a vehicle jumping. For example, the vehicle can avoid collision with the obstacle 202 by jumping. The condition that triggers “jump” comprises a plurality of individual conditions that are bound by an operator “$”. The operator “$” signifies that one of the individual conditions need be met at the present moment. The timing of meeting the conditions may differ. In other words, once a given individual condition is met, the state of the condition being met is maintained until the other individual conditions are met.

The first condition (SPHEREPOS(Z)>150 mm:TIME;1.0 s) is decomposed into (SPHEREPOS(y)>150 mm) and (TIME:1.0 s). SPHEREPOS(y)>150 mm requires that the amount of movement of the light-emitting body 22 in the positive direction aligned with the Y-axis is more than 150 mm, and (TIME:1.0 s) requires that the movement is performed within one second. In other words, the first condition requires that the light-emitting body 22 be moved higher than 150 mm in the positive direction aligned with the Y-axis within one second. The second condition (PITCH>65) requires that the pitch angle of the input device 20 is more than 65°.

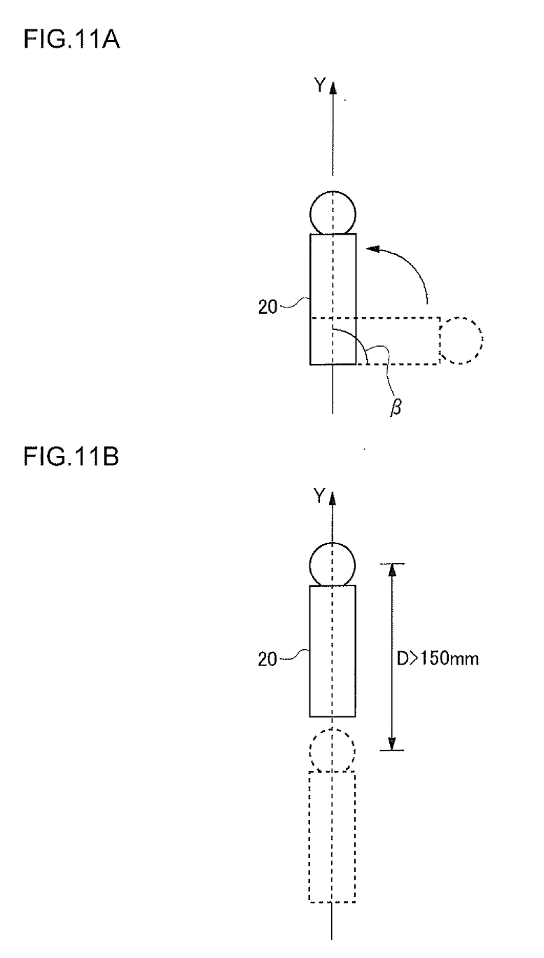

FIG. 11A shows how the second condition is met. The user directs the input device 20 in the positive direction aligned with the Y-axis so that the pitch angle β is more than 65°. Thus, as the user directs the input device 20 substantially in the perpendicular direction, the second condition is met. FIG. 11B shows how the first condition is met. The user moves the input device 20 in the positive direction aligned with the Y-axis. When the amount of movement D of the light-emitting body 22 exceeds 150 mm within one second, the first condition is met. The movement in the positive direction aligned with the Y-axis may not necessarily be the movement of the input device 20 in that direction but signifies the movement of the Y-axis component of the movement of the input device 20. It should be noted that the first condition may be met after the second condition is met. Alternatively, the second condition may be met after the first condition is met. The plurality of individual conditions constituting the condition for operation may occur in any order to trigger a “jump” action. Because the action takes place irrespective of the order of conditions being met, different steps may be performed to initiate the same action, allowing the user to enjoy diversity of maneuvering feeling.

The condition determination unit 112 determines whether the individual conditions for triggering “dash” are met on an individual basis. For a “jump” action to take place, the first condition requires that the input device 20 is moved by a predetermined amount within a predetermined time. More specifically, the first condition requires that the movement of the light-emitting body 22 in the positive direction aligned with the Y-axis exceed 150 mm within one second. When the direction of movement of the light-emitting body 22 changes from the positive direction to the negative direction aligned with the Y-axis, or when the light-emitting body 22 begins to be moved in the positive direction, leaving the stationary state aligned with the Y-axis, the condition determination unit 112 detects the start of movement in the positive direction aligned with the Y-axis and starts measuring the time elapsed from the point of start of the movement. The movement of the light-emitting body 22 in the Y-axis direction is detected by referring to the positional information of the light-emitting body 22. More specifically, the condition determination unit 112 monitors the positional information of the light-emitting body 22 acquired as the control information. The condition determination unit 112 identifies the start of movement when the Y-coordinate value, which is found among the sequentially acquired positional information, changes to positive direction. When the amount of movement of the light-emitting body 22 goes beyond 150 mm within one second, the condition determination unit 112 determines that the first condition is met.

As mentioned before, the positional information of the light-emitting body 22 is derived by the positional information deriving unit 92. The positional information deriving unit 92 is described above as deriving the positional information from the position and size of the image of the light-emitting body. For example, the positional information deriving unit 92 may derive positional information by deriving the amount of movement by integrating the value detected by the three-axis acceleration sensor 56 twice. The positional information deriving unit 92 may use both the image of the light-emitting body and the detected acceleration value to derive the positional information of the light-emitting body 22 so that the precision of derivation is improved. Without an input of the image or the value (e.g., when the light-emitting body 22 is shielded from view so that the image of the light-emitting body cannot be acquired), the positional information of the light-emitting body 22 may be derived only from the detected value of acceleration.

In this embodiment, the first condition may include the requirement requiring that the light-emitting body 22 move continuously in the positive direction aligned with the Y-axis within one second. The requirement for continuous movement signifies that the Y-coordinate values found in the sequentially acquired positional information should remain unchanged or change in the positive direction (i.e., do not change in the negative direction). Therefore, when the light-emitting body 22 is moved in the negative direction aligned with the Y-axis before the amount of movement exceeds 150 mm, the amount of movement is canceled and set to 0. Thus, when the input device 20 is moved in the negative direction before the amount of movement exceeds 150 mm since the start of movement in the positive direction aligned with the Y-axis, the condition determination unit 112 determines that the condition is not met upon detecting the movement in the negative direction.

Thus, when the condition determination unit 112 detects that the light-emitting body 22 is moved continuously for a distance longer than 150 mm within a predetermined period of time (in this case, one second) while the user keeps the light-emitting body 22 raised higher than 150 mm, the condition determination unit 112 determines that the first condition is met. Meanwhile, when the light-emitting body 22 is moved in the negative direction aligned with the Y-axis before continuously moving 150 mm in the positive direction aligned with the Y-axis since the start of movement, the condition determination unit 112 determines at that point of time that the first condition is not met. When the light-emitting body 22 begins to be moved in the positive direction again, the condition determination unit 112 starts measuring time so as to monitor whether the first condition is met.

The condition determination unit 112 determines whether the individual conditions are met on an individual basis. The conditions are bound by an operator “$”. Once a given individual condition is met, the state of the condition being met is maintained until the other individual conditions are met. For each of the first and second conditions, the condition determination unit 112 sets a flag to 1 when the condition is met, and sets the flag to 0 when the condition is not met. In the case that the conditions are bound by the operator “$”, once a given condition is met so that the flag is set by the condition determination unit 112 to 1 accordingly, the flag value of the given condition is maintained until the other condition is met so that the flag for the other condition is set to 1 accordingly, initiating a “jump” action. For example, as shown in FIG. 11A, once the second condition is met so that the flag for the second condition is set to 1, the flag value 1 is maintained even if the pitch angle becomes smaller than 65°. The same holds true for the first condition. When the flags of all conditions are set to 1, the condition determination unit 112 determines that the condition for triggering “jump” is met and informs the object control unit 114 accordingly. The object control unit 114 causes the game object 200 to perform “jump”. The image generation unit 156 generates a display screen showing the vehicle to jump. Since “jump” is performed while the vehicle is moving, the behavior of the vehicle is displayed in the screen such that the vehicle leaves the road surface and traces an arc before touching the ground, while maintaining the forward speed.

In this process, the color setting unit 118 changes the color emitted by the light-emitting body 22 so as to let the user know that the condition for triggering “jump” is met. The color setting unit 118 generates a command to emit light of a color different from the color currently emitted and causes the wireless communication module 86 to transmit the command. In response to the command to emit light, the wireless communication module 48 supplies the command to the main control unit 52, whereupon the main control unit 52 supplies the command to the light-emission control unit 60. The light-emission control unit 60 controls light-emission from the red LED 64a, green LED 64b, blue LED 64c so as to cause the light-emitting unit 62 to emit light of a designated color.

To initiate a “jump” action, the user needs to manipulate the input device 20 so as to meet the condition for operation. In a related type of button operation, an action can be initiated only by pressing a button. The user manipulating the input device 20 according to the embodiment cannot recognize whether the manipulation of the input device 20 meets condition for operation. It is therefore preferable to make the user recognize that the condition for operation to initiate a jump is met by allowing the color setting unit 118 to change the emitted color. In this process, the color setting unit 118 may set different colors for different actions so that the user can know that the manipulation is correct by seeing the color of the light-emitting body 22.

The condition determination unit 112 determines whether the conditions for operation to initiate the actions shown in FIG. 7 are met on an individual basis. Therefore, the condition determination unit 112 may determine that the condition for operation to initiate “turn to left” is met while the object control unit 114 is causing the game object 200 to jump upon determination by the condition determination unit 112 that the condition for operation to initiate “jump” is met. In this case, the object control unit 114 may orient the game object 200 toward left while the game object 200 is performing a jump. Thus, the condition determination unit 112 may determine whether the conditions for operation to initiate an action are met on an individual basis so that the object control unit 114 causes the game object 200 to perform a plurality of actions concurrently.

When a plurality of individual conditions are bound by the operator “$” as in the case of the condition to trigger “jump”, the individual conditions may be met while another action is being performed. For example, when the light-emitting body 22 is raised higher than 150 mm in the Y-axis direction within one second while a “dash” is being performed, the first condition included in the condition for operation is met. In the case that a plurality of individual conditions are bound by the operator “$”, the state of the first condition being met is maintained until the second condition is met. Therefore, the user only has to fulfill the second condition to cause the game object 200 to jump. Similarly, when the pitch angle β of the input device 20 is caused to be larger than 65° while another action is being performed, the second condition is met so that the user only has to fulfill the first condition in order to cause the game object 200 to jump. The user may fulfill one of the individual conditions irrespective of whether another action is being performed and manipulate the input device 20 to fulfill the remaining individual condition when the user desires to perform a jump action. Thus, by associating a plurality of conditions with each other using the operator “$”, the user can determine the timing that each condition is met at will. Therefore, a novel game play that matches the user skill can be created.

The color setting unit 118 may change the color emitted by the light-emitting body 22 so as to let the user know which of the plurality of individual conditions constituting the condition for triggering “jump” is met. The color setting unit 118 assigns different colors to different individual conditions. For example, the color setting unit 118 may cause the light-emitting body 22 to emit green when the first condition is met and blue when the second condition is met. This lets the user know which condition is already met and which condition should be met in order to initiate a “jump” action.

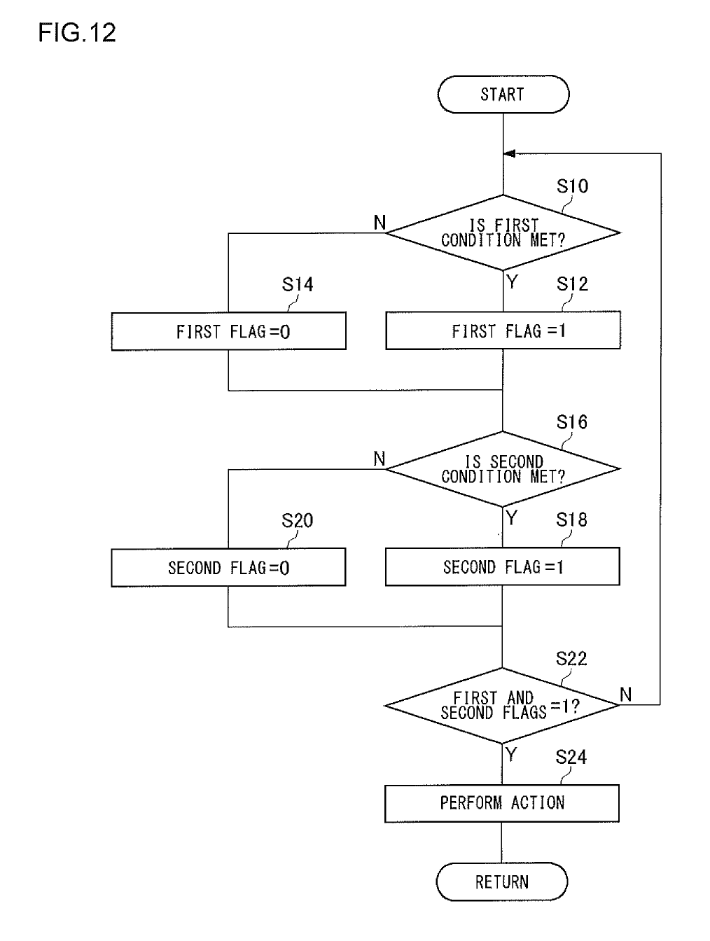

FIG. 12 shows an example of flow of determination on condition performed when a plurality of conditions for operation are defined. Referring to the flowchart shown in FIG. 12, the steps in the respective components are denoted by a combination of S (initial letter of Step), which indicates “step”, and a numeral. When a determination is made in a step denoted by a combination of S and a numeral and when the result of determination is affirmative, Y (initial letter of Yes) is used to indicate the affirmative determination (e.g., Y in S10). Conversely, when the result of determination is negative, N (initial letter of No) is used to indicate the negative determination (e.g., N in S10). The graphical presentation in the flowchart conveys the same meaning in the flowcharts shown in other diagrams.

FIG. 12 illustrates a determination by the condition determination unit 112 performed when a plurality of individual conditions for operation are bound by the operator “&”. The operator “&” signifies that the individual conditions should be met concurrently. The operator “&” is explained above in the example of “dash” action. It is assumed in FIG. 12 that two conditions, namely, the first condition and the second condition, are bound by “&” for convenience of the description. A flag indicating whether the first condition is met will be referred to as the first flag, and a flag indicating whether the second condition is met will be referred to as the second flag.

The condition determination unit 112 determines whether the first condition is met by referring to the control information (S10). When the first condition is met (Y in S10), the condition determination unit 112 sets the first flag to 1 (S12). When the first condition is not met (N in S10), the first flag is set to 0 (S14). Concurrently, the condition determination unit 112 determines whether the second condition is met by referring to the control information (S16). When the second condition is met (Y in S16), the condition determination unit 112 sets the second flag to 1 (S18). When the second condition is not met (N in S16), the second flag is set to 0 (S20).

The condition determination unit 112 determines whether both the first and second flags are set to 1 (S22). When both flags are set to 1 (Y in S22), the object control unit 114 performs an associated action (S24). Meanwhile, when at least one of the first and second flags is set to 0 (N in S22), steps beginning with S10 are performed again.

As described, according to the flow of determination on condition, the action is not performed unless the first and second conditions are met concurrently. Accordingly, actions that require user skill are implemented.

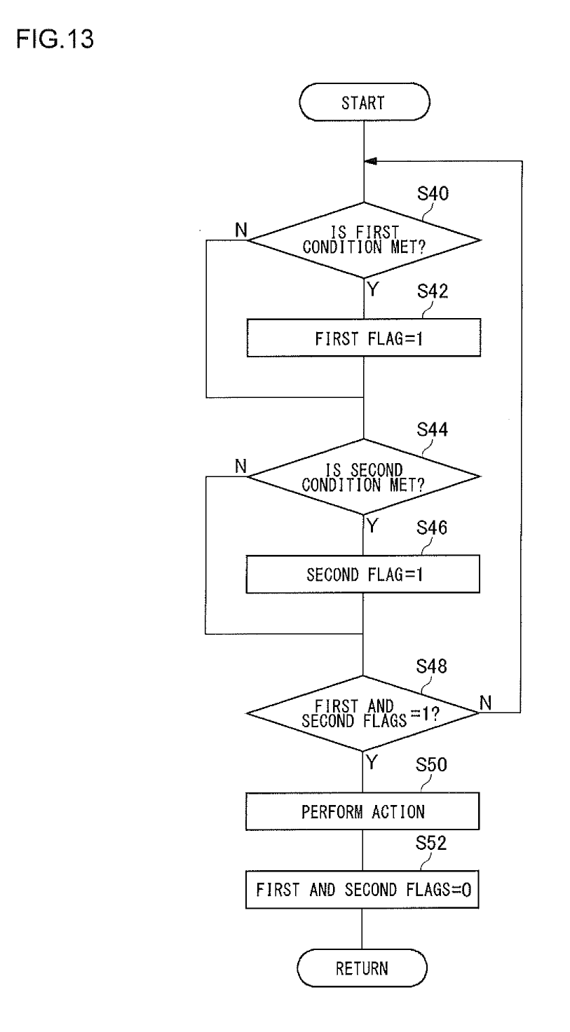

FIG. 13 shows an example of flow of determination on condition performed when a plurality of individual conditions for operation are defined. FIG. 13 illustrates a determination by the condition determination unit 112 performed when a plurality of individual conditions for operation are bound by the operator “$”. The operator “$” signifies that the individual conditions need not be met concurrently and that the conditions should be met at the present moment. The operator “$” is explained above in the example of “jump” action. It is assumed in FIG. 13 that two conditions, namely, the first condition and the second condition, are bound by “$”. A flag indicating whether the first condition is met will be referred to as the first flag, and a flag indicating whether the second condition is met will be referred to as the second flag. It will be assumed that the flow of determination on condition is started while the first and second flags are both set to 0.

The condition determination unit 112 determines whether the first condition is met by referring to the control information (S40). When the first condition is met (Y in S40), the condition determination unit 112 sets the first flag to 1 (S42). When the first condition is not met (N in S40), the first flag remains unchanged. Concurrently, the condition determination unit 112 determines whether the second condition is met by referring to the control information (S44). When the second condition is met (Y in S44), the condition determination unit 112 sets the second flag to 1 (S46). When the second condition is not met (N in S44), the second flag remains unchanged.

The condition determination unit 112 determines whether both the first and second flags are set to 1 (S48). When both flags are set to 1 (Y in S48), the object control unit 114 performs an associated action (S50) and sets the first and second flags to 0 (S52). Meanwhile, when at least one of the first and second flags is set to 0 (N in S48), steps beginning with S40 are performed again.

As described, according to the flow of determination on condition, once a condition is met, the flag continues to be set to 1 even if the condition is not met any more subsequently. By maintaining a state in which a condition is met, the user can fulfill the last condition at a desired point of time and control the game object 200 at will.

Described above is an explanation based on an exemplary embodiment. The embodiment is intended to be illustrative only and it will be obvious to those skilled in the art that various modifications to constituting elements and processes could be developed and that such modifications are also within the scope of the present invention.

1. A computer program embedded in a non-transitory computer-readable recording medium, comprising:
a module configured to determine whether control information indicating an operation of an input device meets a predetermined condition for operation; and
a module configured to cause, when the condition for operation is determined to be met, an object to perform an action mapped to the condition for operation,
wherein the predetermined condition for operation requires that the input device be moved by a predetermined amount within a predetermined period of time, and
wherein the determination module measures time elapsed since the start of a movement of the input device and determines, when the input device is moved by the predetermined amount within the predetermined period of time, that the condition for operation is met.

2. The computer program according to claim 1,
wherein the predetermined condition for operation requires that the input device be moved by the predetermined amount in a predetermined direction within the predetermined period of time, and
wherein the determination module measures time elapsed since the start of the movement of the input device and determines, when the input device is moved by the predetermined amount in the predetermined direction within the predetermined period of time, that the condition for operation is met.

3. The computer program according to claim 2, wherein the determination module includes a module configured to determine, when the input device is moved in a direction opposite to the predetermined direction before being moved by the predetermined amount in the predetermined direction since the start of the movement of the input device, that the condition for operation is not met.

4. The computer program according to claim 1, wherein
the condition for operation includes a plurality of individual conditions,
the determination module includes a module configured to determine whether each individual condition is met before determining whether the condition for operation is met, and
the module for object control includes a module configured to cause the object to perform an action mapped to the condition for operation including the plurality of individual conditions.

5. The computer program according to claim 4, wherein the determination module includes a module configured to determine whether all of the individual conditions are concurrently met.

6. The computer program according to claim 4, wherein the determination module includes a module configured to determine whether all of the individual conditions are met up to the present moment.

7. A computer program embedded in a non-transitory computer-readable recording medium, comprising:
a module configured to determine whether control information indicating an operation of an input device meets a predetermined condition for operation; and
a module configured to cause, when the condition for operation is determined to be met, an object to perform an action mapped to the condition for operation,
wherein the condition for operation to cause the object to jump in a game space requires that the input device be directed substantially in the vertical direction and that the input device be moved upward in the vertical direction, and
wherein when the determination module determines that the condition for operation to cause the object to jump is met, the module for object control causes the object to jump in the game space.

8. The computer program according to claim 7, wherein the condition requiring that the input device be moved upward in the vertical direction requires that the input device be moved by a predetermined amount within a predetermined period of time.

9. A non-transitory computer-readable recording medium having embodied thereon a computer program that operates to cause a processing system to execute actions, comprising:
determining whether control information indicating an operation of an input device meets a predetermined condition for operation, the predetermined condition for operation requiring that the input device to be moved by a predetermined amount within a predetermined period of time
measuring time elapsed since the start of a movement of the input device;
determining, when the input device is moved by the predetermined amount within the predetermined period of time, that the condition for operation is met; and
causing an object to perform an action mapped to the condition for operation, only when the condition for operation is determined to be met.

10. An object control method adapted to cause an object to perform an action in accordance with an operation using an input device, comprising:
acquiring an image of an input device having a light-emitting body;
acquiring control information indicating an operation of the input device by referring to positional information of the input device derived from the acquired image, and/or orientation information of the input device;
storing the correspondence between a predetermined action of the object and a condition for operation of the input device;
determining whether the control information meets the condition for operation; and
causing, when the condition for operation is determined to be met, the object to perform an action mapped to the condition for operation,
wherein said storing involves the storing of a condition for operation requiring that the input device be moved by a predetermined amount within a predetermined period of time, and
said determination measures time elapsed since the start of a movement of the input device and determines, when the input device is moved by the predetermined amount within the predetermined period of time, that the condition for operation is met.

11. A game device adapted to cause an object to perform an action in accordance with an operation using an input device, comprising:
an image acquisition unit configured to acquire an image of an input device having a light-emitting body;
a control information acquisition unit configured to acquire control information indicating an operation of the input device by referring to positional information of the input device derived from the acquired image, and/or orientation information of the input device;
a storage unit configured to store the correspondence between a predetermined action of the object and a condition for operation of the input device;
a condition determination unit configured to determine whether the control information meets the condition for operation stored in the storage unit; and
an object control unit configured to cause, when the condition for operation is determined to be met by the condition determination unit, the object to perform an action mapped to the condition for operation,
wherein the storage unit stores a condition for operation requiring that the input device be moved by a predetermined amount within a predetermined period of time, and
wherein the condition determination unit measures time elapsed since the start of a movement of the input device and determines, when the input device is moved by the predetermined amount within the predetermined period of time, that the condition for operation is met.
